(19) United States
(12) Patent Application Publication
(10) Pub. No.: US 2025/0230773 A1
(43) Pub. Date: Jul. 17, 2025

(54) SYSTEMS, METHODS, AND APPARATUSES OF GAS TURBINE COOLING

(71) Applicant: ConocoPhillips Company, Houston, TX (US)

(72) Inventors: Carl Jonas RYDLAND, Houston, TX (US); Carlo DE BERNARDI, Houston, TX (US)

(21) Appl. No.: 19/024,486

(22) Filed: Jan. 16, 2025

Related U.S. Application Data
(60) Provisional application No. 63/621,639, filed on Jan. 17, 2024.

(51) Int. Cl. F02C 7/12

(52) U.S. Cl. CPC F02C 7/12; F05D 2260/2214

(57) ABSTRACT

Aspects of the present disclosure relate generally to systems, methods, and devices for cooling a gas-powered turbine. The system includes a plurality of gas-powered turbine components, such as a combustion chamber having an interior portion. An internal cooling circuit with a heat shield is disposed at least partly in the interior portion of the combustion chamber. The heat shield is positioned axially and/or along a lengthwise axis of the combustion chamber, while omitting radial portions extending outward towards an outer surface of the gas-powered turbine. Additionally, the heat shield is positioned upstream from and/or outside of a hot gas path formed downstream of the combustion chamber away from moving/rotating components. The heat shield is an additive manufacturing heat shield formed of an additive manufacturing process (e.g., 3D printing).

### CROSS-REFERENCE TO RELATED APPLICATIONS

The present application claims priority to U.S. Provisional Patent Application No. 63/621,639 filed on Jan. 17, 2024, which is incorporated by reference in its entirety herein.

### FIELD

Aspects of the present disclosure relate generally to systems and methods for turbine cooling and more particularly to gas-powered turbine cooling with heat shields.

### BACKGROUND

Gas powered turbines are a prime power source worldwide due to their portability and efficiency, powering everything from airplanes and tanks, to powerplants and factories. Gas powered turbines are located on islands, in the artic, on offshore oil rigs, and in other remote locations. Because of the variety and remote location of these turbines, access to spare parts in a timely manner is challenging. Manufacturing is additionally challenging due to the specialized materials and properties of the components. As such, components are typically expensive to replace and can have lead times up to 18-60 months. Problems are further exacerbated by premature wear of the components.

### SUMMARY

Implementations described and claimed herein address the foregoing problems by providing systems, methods, and apparatuses for gas turbine cooling. In some examples, the system can include a combustion chamber of a gas turbine with an interior portion; and/or a heat shield of an internal cooling circuit. The heat shield can be formed by additive manufacturing and can be at least partly disposed inside the combustion chamber. Furthermore, the heat shield can be formed by additive manufacturing of a crystal structure using a base powder material. Additionally, the heat shield can extend axially into the interior portion of the combustion chamber. The heat shield can also extend into the interior portion of the combustion chamber substantially parallel to a central axis of the combustion chamber. The heat shield can have a base portion extending radially, and one or more divider walls can extend axially from the base portion. The divider walls can extend at an angle from the base portion (e.g., substantially perpendicularly and/or non-radially). Moreover, the heat shield can be disposed upstream and downstream from rotating components of the gas turbine. The rotating components can include one or more of a turbine blade or an exhaust fan.

In some instances, a gas turbine cooling device includes a heat shield of an internal cooling circuit configured to extend into an interior portion of a combustion chamber of a gas turbine. The heat shield can be additively manufactured starting from layers of metal powder. The additively manufactured heat shield metallographic structure is further refined by the heat treatment step of the manufacturing process. Additionally, the heat shield can extend into the interior portion of the combustion chamber, at least partly, along a central axis of the combustion chamber. The heat shield can also extend, at least partly, along an axis defined by an arrangement of the combustion chamber with a fuel injector assembly. Moreover, the heat shield can extend, at least partly, along an axis defined by an arrangement of the combustion chamber with a turbine. By way of example, the heat shield can also extend into the interior portion to align the internal cooling circuit axially/non-radially. The heat shield can be disposed in the gas turbine around static components of the gas turbine. Also, the heat shield can be disposed upstream from a hot gas path of the gas turbine.

In some scenarios, a method of cooling a gas turbine includes forming an additively manufactured heat shield of an internal cooling circuit using an additive manufacturing machine; disposing the additively manufactured heat shield at least partly inside a combustion chamber of a gas turbine system; and/or reducing a temperature of the gas turbine system by circulating a cooling fluid through the internal cooling circuit. Forming the additively manufactured heat shield can include forming a metallographic structure from layers of metal powder via an additive manufacturing machine. Furthermore, disposing the additive manufacturing-based heat shield in the gas turbine system can include disposing the additively manufactured heat shield in a static portion of the gas turbine system upstream from rotating components. Also, reducing the temperature of the gas turbine system can include circulating the cooling fluid at least partly through an interior portion of the combustion chamber. For instance, the cooling fluid can flow axially and/or non-radially through the interior portion of the combustion chamber.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for cooling a gas-powered turbine with an additively manufactured heat shield.

FIG. 2 illustrates an example system using additive manufacturing to form a heat shield used to protect internal and external components of the gas turbine from heat.

FIG. 3 illustrates an example method of cooling a gas-powered turbine which can be performed by the systems depicted in FIGS. 1 and 2.

FIG. 4 illustrates an example initial heat shield to form the basis of an additively manufactured heat shield.

FIGS. 5A and 5B illustrate example initial heat shield portions to form the basis of additively manufactured heat shield portions.

FIGS. 5C and 5D illustrate example additively manufactured heat shield portions.

### DETAILED DESCRIPTION

Systems, devices, and methods disclosed herein include a cooling system for a gas-powered turbine. The cooling system can include an additively manufactured shield containing an internal cooling circuit extending axially into a combustion chamber of the gas-powered turbine. The additively manufactured shield can be extremely resilient and able to withstand extreme conditions, for instance, with better oxidation resistance and ductility which increases durability over other heat shields. These types of heat shields can also be created quicker, and cheaper than the previous designs. Furthermore, using additive manufacturing techniques to form the heat shield can redesign the cooling air flow path to provide for more efficient cooling, which can lead to longer component life throughout the system.

Additional benefits and advantages will become apparent from the detailed disclosure below.

In the description, phraseology and terminology are employed for the purpose of description and should not be regarded as limiting. For example, the use of a singular term, such as “a”, is not intended as limiting of the number of items. Also, the use of relational terms in the description for clarity in specific reference to the figures are not intended to limit the scope of the present inventive concept or the appended claims. Further, any one of the features of the present inventive concept may be used separately or in combination with any other feature. For example, references to the term “implementation” means that the feature or features being referred to are included in at least one aspect of the presently disclosed technology. Separate references to the term “implementation” in this description do not necessarily refer to the same implementation and are also not mutually exclusive unless so stated and/or except as will be readily apparent to those skilled in the art from the description. For example, a feature, structure, process, step, action, or the like described in one implementation may also be included in other implementations but is not necessarily included. Thus, the presently disclosed technology may include a variety of combinations and/or integrations of the implementations described herein. Additionally, all aspects of the presently disclosed technology as described herein are not essential for its practice.

Lastly, the terms “or” and “and/or” as used herein are to be interpreted as inclusive or meaning any one or any combination. Therefore, “A, B or C” or “A, B and/or C” mean any of the following: “A”; “B”; “C”; “A and B”; “A and C”; “B and C”; or “A, B and C.” An exception to this definition will occur only when a combination of elements, functions, steps or acts are in some way inherently mutually exclusive.

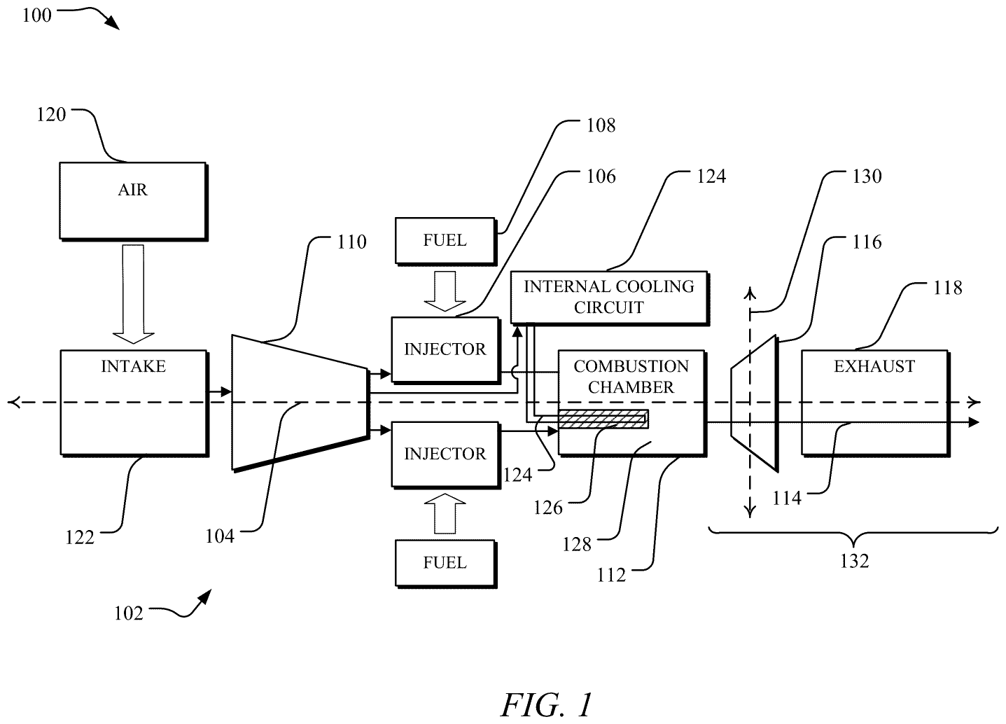

To begin a detailed discussion of an example system 100 for cooling a gas turbine 102, reference is made to FIG. 1. In one implementation, the gas turbine 102 can include a plurality of components, which can be arranged axially and/or along a component axis 104. These components can include one or more fuel injectors 106 to inject fuel 108 from a fuel supply, and a compressor 110 to send compressed air forming an air/fuel mixture in a combustion chamber 112. Hot combustion exhaust air can leave the combustion chamber 112 along a hot gas path 114 into a turbine blade assembly 116 and out an exhaust 118 (e.g., downstream and/or in the axial direction of the component axis 104). The compressor 110 can receive intake air 120 from an intake 122, and the turbine blade assembly 116 can drive the compressor 110 and connect to a load shaft.

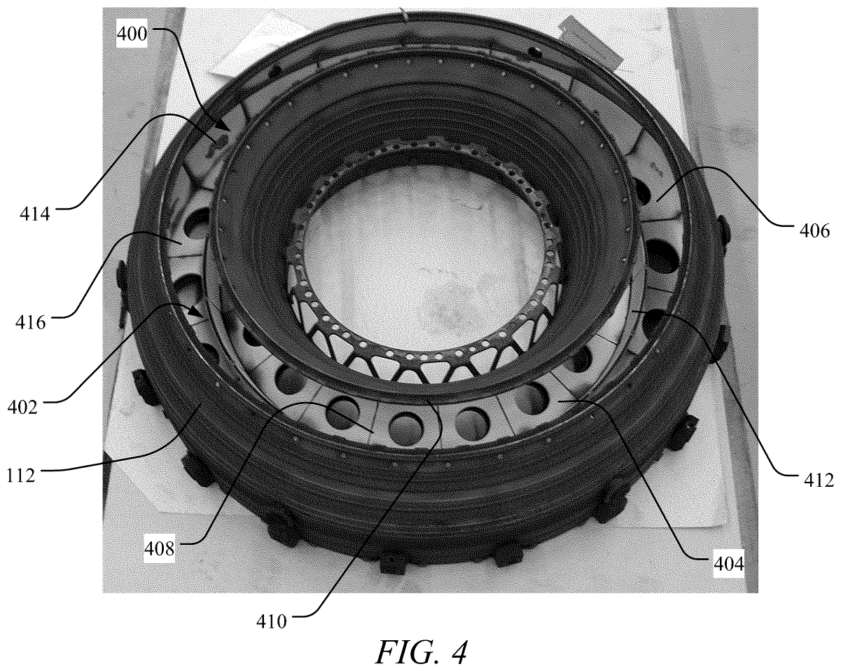

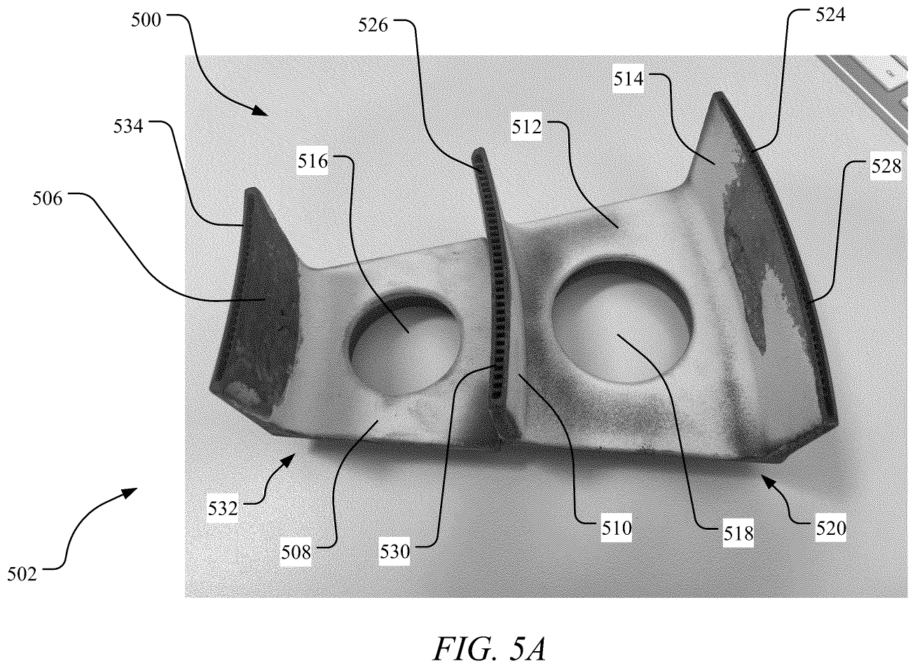

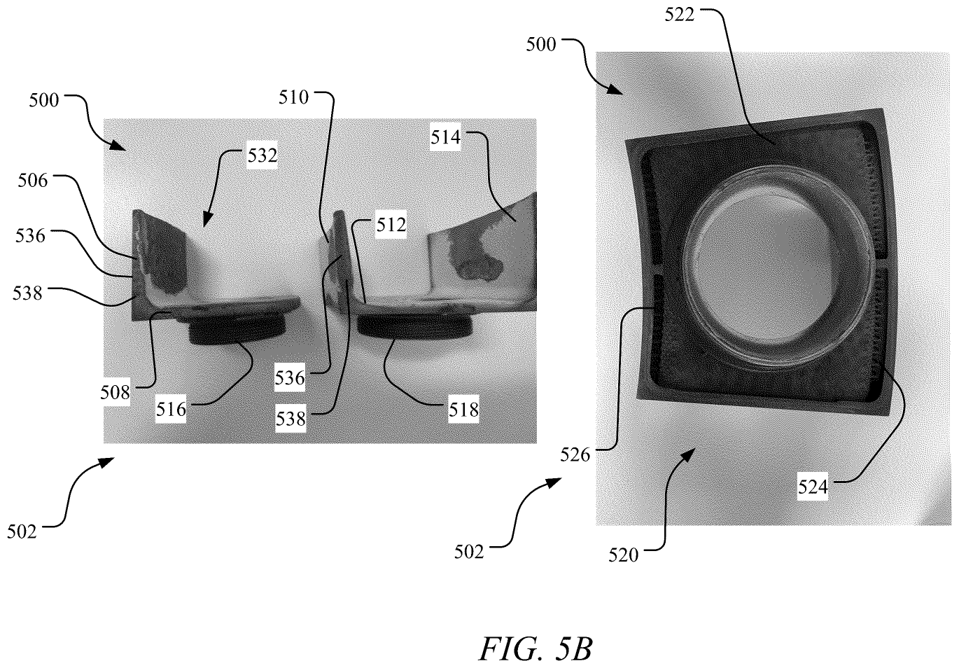

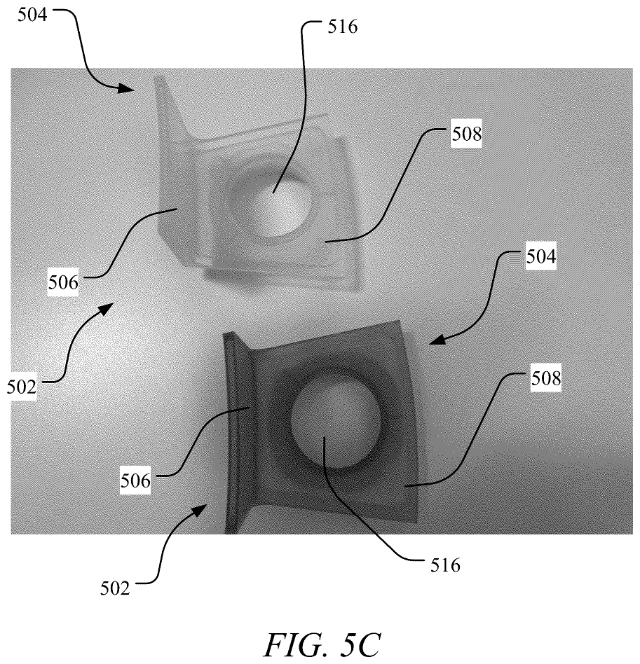

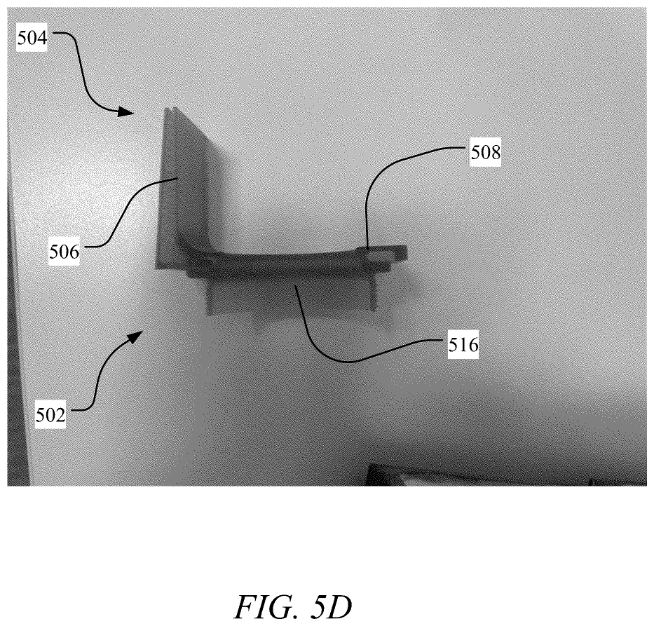

Furthermore, the system 100 can include an internal cooling circuit 124 for cooling one or more of these components. The internal cooling circuit 124 can be protected by a heat shield 126 forming an inner portion and an outer portion around the internal cooling circuit 124 to control a flow of cooling fluids around the component(s) of the gas turbine 102 being cooled (e.g., as discussed in greater detail below regarding FIGS. 4-5D). The internal cooling circuit 124 can extend at least partly into an interior portion 128 of the combustion chamber 112. The heat shield 126 can include an inner heat shield portion with a first base surface extending radially from an inner wall of the heat shield 126. An outer heat shield portion with a second base surface can also extend radially from a divider wall of the heat shield 126 to an outer wall of the heat shield 126. The divider wall can divide the inner heat shield portion from the outer heat shield portion. Additionally, the outer wall can define an outer perimeter of the heat shield 126. The inner wall, the divider wall, and the outer wall can extend substantially parallel to each other and/or can extend axially (e.g., non-radially), as discussed in greater detail below regarding FIGS. 4-5D. Using this design, the internal cooling circuit 124 with the heat shield 126 can extend deeper into the combustion chamber 112 and provide additionally cooling.

During operation, the internal cooling circuit 124 can circulate a cooling fluid through tubing, pipes, channels, and/or openings at least partially enclosed by the heat shield 126, such that the cooling fluid flows through the internal cooling circuit 124, axially and/or non-radially (e.g., while omitting cooling circuit pathways directed in a radial direction 130 towards an outer surface of the gas turbine 102). Accordingly, the cooling fluid can move axially through the interior portion 128 of the combustion chamber 112 to reduce the temperature of the gas turbine 102.

In some examples, the components of the gas turbine 102 can include a subset of components which are downstream components 132, that is, downstream from the combustion chamber 112. The downstream components 132 can include the turbine blade assembly 116, the exhaust 118, and/or any other components in the hot gas path 114 downstream from the combustion chamber 112. Furthermore, the downstream components 132 and/or components in the hot gas path 114 can be moving and/or rotating components (e.g., the blades of the turbine blade assembly 116 and/or blades of an exhaust fan). The internal cooling circuit 124 with the heat shield 126 can be upstream from the downstream components 132 which move and/or rotate. In other words, the position of the internal cooling circuit 124 and/or the heat shield can be a static environment enclosed by and/or adjacent to static components that do not move or have any rotating components (e.g., the interior portion 128 of the combustion chamber 112), rather than being adjacent to or operating in conjunction with moving/rotating components such as the turbine blade assembly 116. Furthermore, the internal cooling circuit 124 and/or the heat shield 126 can be positioned upstream from hot gas path 114 and the downstream components 132 in the hot gas path 114, such that the internal cooling circuit 124 and/or the heat shield 126 can avoid exposure to the high temperatures of the hot gas path 114. Accordingly, in some scenarios, the heat shield 126 can have reduced wear and an extended operational lifetime by being positioned in the static environment upstream from the moving downstream components 132 in the hot gas path 114.

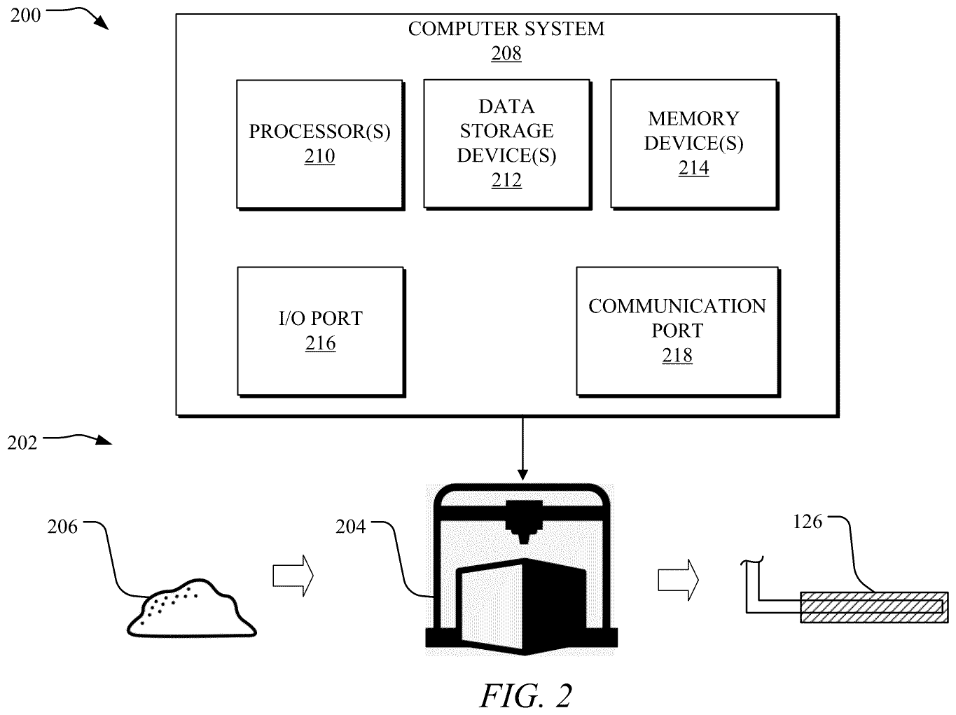

Referring to FIG. 2, an example system 200 for cooling a gas turbine 102 is depicted. The system 200 shown in FIG. 2 can be similar to, identical to, and/or can form at least a portion of the system 100 shown in FIG. 1.

In some examples, the heat shield 126 and/or at least portions of the heat shield 126 (e.g., an inner heat shield inside the combustion chamber 112 and an outer heat shield portion) can be formed of an additive manufacturing process 202. The additive manufacturing process 202 can include an additive manufacturing machine 204 (e.g., a three-dimensional (3D) printing machine) for receiving a base material 206 or base powder and forming the heat shield 126 and/or portions of the heat shield 126 by depositing a plurality of layers bonded. The additive manufacturing process 202 can include additional heat treatment, thermal barrier coating, mixing, and/or curing steps for bonding the internal structure of the heat shield 126 into a single crystal-like piece, for instance, with properties similar to or improved over single crystal Rene N5. As such, the additively manufactured heat shield 126 and/or portions of the heat shield 126 can be extremely resilient and able to withstand the extreme conditions of the interior portion 128 of the combustion chamber 112.

By way of example, the base material 206 can include a powder comprising Aluminum (Al), Boron (B), Carbon (C), Chromium (Cr), Cobalt (Co), Copper (Cu), Iron (Fe), Manganese (M), Molybdenum (Mo), Niobium (Nb), Nickle (Ni), Phosphorous (P), Silica (Si), Sulfur(S), Tantalum (Ta), Titanium (Ti), Tungsten (W), Vanadium (V), Zirconium (Zr), and alloy combinations thereof. In some implementations, a superalloy powder may be used including a Ni-based superalloy, Ti-based superalloy, Co—Ni superalloy, Ni—Cr superalloy. In some embodiments the base material 206 is a superalloy featuring a high y′-phase content. For example, a variety of alloy powders that are commercially available including Superally 718, ATI 718PLUS®, Waspaloy, HAYNES®282®, LW4280, LW4280W, LW4280LCT, ZGH451-1, GRX-810, GAMMAPRINT™-1100, ABD-1000, STAL-15, and other commercially available alloy powders may be used. Furthermore, the additive manufacturing process 202 can include one or more phases/operations of a laser powder bed fusion (LPBF) process.

For example, the additive manufacturing process 202 can include a first operation of generating a finite element analysis/method (FEA/FEM) of the heat shield 126. This first operation can involve producing a full 3D model of the heat shield 126. Additionally, full transient thermal boundary conditions can be developed, such as full start-up, steady state, and shut down. This first operation can also include performing transient thermal analysis (e.g., using the transient thermal boundary conditions); developing a full transient mechanical boundary conditions; performing a transient mechanical stress analysis; producing results for steady stresses, low cycle fatigue stresses, and creep stress analysis; and/or comparing operating mechanical and thermal results to the corrosion properties of the two materials to determine effective life expectations.

The additive manufacturing process 202 can also include a second phase/operation of designing production and development processes for manufacturing the heat shield 126. The second phase/operation can involve one or more of incorporating LPBF machining tolerances; generating drawings of the heat shield 126 for final machining and inspections; developing tooling for machining the heat shield 126; performing process documentation for non-destructive testing by fluorescent penetrant inspection (FPI) and radiographic inspection; performing tooling, process documentation and/or parameters for the application of bond and thermal barrier coatings (TBC); and/or performing tooling and/or process documentation for air flow inspection.

The additive manufacturing process 202 can include a third phase/operation of manufacturing the heat shield 126. This third phase/operation can involve one or more of procuring the selected powder; developing the process parameters and process documentation for three-dimensional additive manufacturing by LPBF of the inner heat shield portion and/or the outer heat shield portion of the heat shield 126; producing inner and outer heat shields for demonstration, non-destructive testing (NDT) and qualification of process parameters by LPBF; performing heat treatment of the heat shield 126; and/or qualifying the inner and outer heat shields by LPBF process as per AMSL 3 API STND 20S standards for tensile properties established at the first phase/operation. In some examples, impact testing may be omitted due to a thickness of the heat shield 126 and functionality. The third phase/operation of manufacturing the heat shield 126 can also include producing two (2) inner and two (2) outer heat shields with LPBF for engine testing., produced in accordance with API STND 20S, AMSL 3; performing heat treatment for the heat shield portions; machining two (2) inner and two (2) outer heat shields to final dimensions; performing an NDT inspection; performing an air flow test; applying the bond; performing aging heat treatment to the heat shield 126; applying thermal barrier coatings (TBC) to the heat shield 126; performing a final air flow test; and/or performing final inspection of the two (2) inner and two (2) outer heat shields. Then the heat shield 126 can undergo installation, engine performance testing, operation, and/or operational monitoring (e.g., borescope inspections at regular intervals of use).

In some instances, any of the phases/operations disclosed herein can be performed for one or both of the inner heat shield portion and/or the outer heat shield portion of the heat shield 126. Additionally, the operations of the additive manufacturing process 202 and/or the resulting product can apply some of the technical requirements of the API 20S Standard.

Further, any of the manufacturing and/or operational steps of the gas turbine 102 disclosed herein can be at least partly performed by an example computing system 208 having one or more computing units that may implement various systems and methods discussed herein. The computing system 208 may form a part of and/or be in communication with the additive manufacturing machine 204 and/or can perform the operations of the additive manufacturing process 202 discussed herein. It will be appreciated that specific implementations of these devices may be of differing possible specific computing architectures not all of which are specifically discussed herein but will be understood by those of ordinary skill in the art.

The computing system 208 may be a computing system is capable of executing a computer program product to execute a computer process to control any of the operations of the additive manufacturing machine 204 discussed herein. Data and program files may be input to the computing system 208, which reads the files and executes the programs therein. Some of the elements of the computing system 208 are shown in FIG. 2, including one or more hardware processors 210, one or more data storage devices 212, one or more memory devices 214, and/or one or more ports 216-218. Various elements of the computing system 208 may communicate with one another by way of one or more communication buses, point-to-point communication paths, or other communication means.

The processor 210 may include, for example, a central processing unit (CPU), a microprocessor, a microcontroller, a digital signal processor (DSP), and/or one or more internal levels of cache. There may be one or more processors 210, such that the processor 210 comprises a single central-processing unit, or a plurality of processing units capable of executing instructions and performing operations in parallel with each other, commonly referred to as a parallel processing environment.

The computing system 208 may be a computer, a distributed computer, or any other type of computer, such as one or more external computers made available via a cloud computing architecture. The presently described technology is optionally implemented in software stored on the data stored device(s) 212, stored on the memory device(s) 214, and/or communicated via one or more of the ports 216-218, thereby transforming the computing system 208 in FIG. 2 to a special purpose machine for implementing the operations described herein. Examples of the computing system 208 include personal computers, terminals, workstations, mobile phones, tablets, laptops, personal computers, multimedia consoles, gaming consoles, set top boxes, and the like.

The one or more data storage devices 212 may include any non-volatile data storage device capable of storing data generated or employed within the computing system 208, such as computer executable instructions for performing a computer process, which may include instructions of both application programs and an operating system (OS) that manages the various components of the computing system 208. The data storage devices 212 may include, without limitation, magnetic disk drives, optical disk drives, solid state drives (SSDs), flash drives, and the like. The data storage devices 212 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 214 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 212 and/or the memory devices 214, which may be referred to as machine-readable media. For instance, the one or more memory devices 214 can store operational instructions for the additive manufacturing machine 204, such as 3D printing control functions, dimensions of the heat shield 126, temperature thresholds, calibration data, and so forth. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing system 208 includes one or more ports, such as an input/output (I/O) port 216 and a communication port 218, for communicating with other computing, network, or the additive manufacturing machine 204. It will be appreciated that the ports 216-218 may be combined or separate and that more or fewer ports may be included in the computing system 208.

The I/O port 216 may be connected to an I/O device, or other device, by which information is input to or output from the computing system 208. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 208 via the I/O port 216. Similarly, the output devices may convert electrical signals received from computing system 208 via the I/O port 216 into signals that may be sensed as output by a human, such as sound, light, and/or touch. The input device may be an alphanumeric input device, including alphanumeric and other keys for communicating information and/or command selections to the processor 210 via the I/O port 216. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 208 via the I/O port 216. For example, an electrical signal generated within the computing system 208 may be converted to another type of signal, and/or vice-versa. In one implementation, the environment transducer devices sense characteristics or aspects of an environment local to or remote from the computing system 208, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing system 208, such as, physical movement of some object (e.g., a mechanical actuator), heating or cooling of a substance, adding a chemical substance, and/or the like.

In one implementation, a communication port 218 is connected to a network by way of which the computing system 208 may receive network data useful in executing the methods and systems set out herein as well as transmitting information and network configuration changes determined thereby. Stated differently, the communication port 218 connects the computing system 208 to one or more communication interface devices configured to transmit and/or receive information between the computing system 208 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 218 to communicate one or more other machines, either directly over a point-to-point communication path, over a wide area network (WAN) (e.g., the Internet), over a local area network (LAN), over a cellular (e.g., third generation (3G), fourth generation (4G), or fifth generation (5G)) network, or over another communication means. Further, the communication port 218 may communicate with an antenna or other link for electromagnetic signal transmission and/or reception.

In an example, data files, software and other modules and services may be embodied by instructions stored on the data storage devices 212 and/or the memory devices 214 and executed by the processor 210.

The system 200 set forth in FIG. 2 includes but one possible example of a computer system 208 that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches.

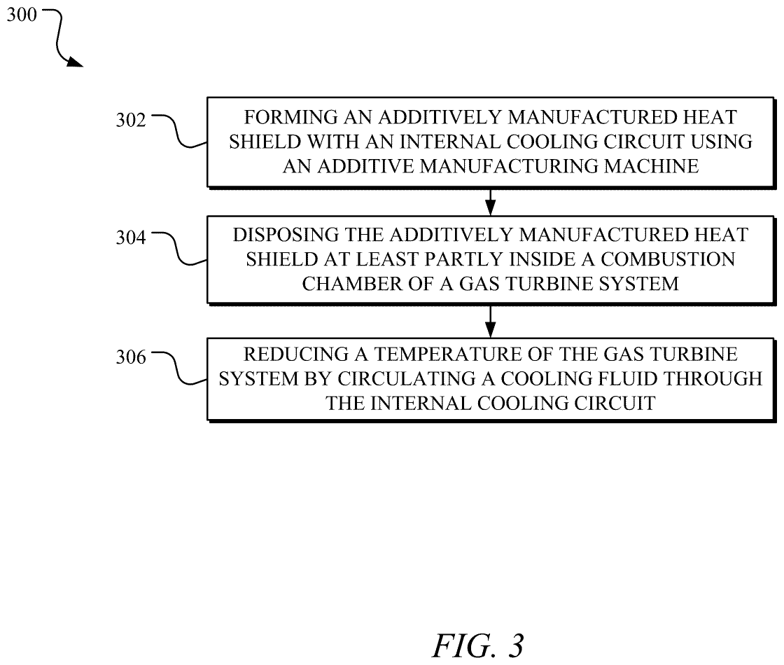

FIG. 3 illustrates an example method 300 of cooling a gas turbine 102, which can be performed by the system(s) 100, 200 depicted in FIGS. 1 and 2.

In some instances, at operation 302, the method 300 can form an additively manufactured heat shield of an internal cooling circuit using an additive manufacturing machine. At operation 304, the method 300 can dispose the additively manufactured heat shield at least partly inside a combustion chamber of a gas turbine system. At operation 306, the method 300 can reduce a temperature of the gas turbine system by circulating a cooling fluid through the internal cooling circuit.

It is to be understood that the specific order or hierarchy of steps in the method(s) depicted throughout this disclosure are instances of example approaches and can be rearranged while remaining within the disclosed subject matter. For instance, any of the operations depicted throughout this disclosure may be omitted, repeated, performed in parallel, performed in a different order, and/or combined with any other of the operations depicted throughout this disclosure.

FIG. 4 illustrates an example initial heat shield 400 inside the combustion chamber 112. The initial heat shield 400 shown in FIG. 4 can be similar to, identical to, and/or can form at least a portion of the system 100 shown in FIG. 1.

In some instances, the initial heat shield 400 has a shape 402 forming the basis of an additively manufactured heat shield (e.g., the heat shield 126). For instance, one or more portions of the initial heat shield 400 (e.g., heat shield portions 500 in FIGS. 5A-5B) and/or the entire initial heat shield 400 can have a shape 402 and/or dimensions which are used by the additive manufacturing process 202 to form a replacement additively manufactured heat shield, or replacement additively manufactured components for the heat shield 400. Additively manufactured replacement components can be generated in response to wear, cracking, and/or degradation of the initial heat shield 400.

In some examples, the initial heat shield 400 and/or the additively manufactured heat shield (e.g., having the same shape 402 as the initial heat shield 400) can include an inner heat shield portion 404 and an outer heat shield portion 406. The inner heat shield portion 404 can have a first base surface 408 which extends radially from an inner wall 410. A divider wall 412 can extend between the inner heat shield portion 404 and the outer heat shield portion 406 (e.g., in an axial direction and/or non-radially). Furthermore, the outer heat shield portion 406 can include an outer wall 414 extending from a second base surface 416 of the outer heat shield portion 406, defining an outer perimeter of the outer heat shield portion 406. As such, the inner heat shield portion 404 can form an inner ring of the combustion chamber 112, and the outer heat shield portion 406 can form an outer ring of the outer heat shield portion 406 disposed around the inner ring. The inner heat shield portion 404 and the outer heat shield portion 406 can be formed of a plurality of segments or sub-portions, as discussed in greater detail below regarding FIGS. 5A-5E.

FIGS. 5A and 5B illustrate one or more heat shield portions 500. The one or more heat shield portions 500 shown in FIGS. 5A and 5B can be similar to, identical to, and/or can form at least a portion of the system 100 (e.g., the combustion chamber 112) shown in FIG. 1.

In some examples, the heat shield portions 500 can have a shape 502 forming the basis of the additively manufactured heat shield portions 504 depicted in FIGS. 5C and 5D, for instance, to be used as replacement components when the heat shield portions 500 of the initial heat shield 400 become spent, cracked, degraded, or worn through usage. A heat shield portion 500 can include a section 506 of the inner wall 410 extending (e.g., perpendicularly) from a section 508 of the first base surface 408 of the inner heat shield portion 404. A section 510 of the divider wall 412 can extend parallel to the section 506 of the inner wall 410 and can divide the section 508 of the first base surface 408 from a section 512 of the second base surface 416. Furthermore, a section 514 of the outer wall 414 can form a portion of the outer perimeter of the heat shield 126. The first base surface 408 can have a first opening 516 for receiving an inner fuel nozzle of a ring of inner fuel nozzles which protrudes into the combustion chamber. The second base surface 416 can also have a second opening 518 for receiving an outer fuel nozzle of a ring of outer fuel nozzles which also protrudes into the combustion chamber. Additionally, it is to be understood that a plurality of the heat shield portions 500 can be arranged in a circle to form the heat shield 126 in a circular configuration.

Furthermore, in some instances, an outer heat shield section 520 can have a bottom area 522 which “floods” with cooling air during operation. This can cause the cooling air of the internal cooling circuit 124 to pass through a plurality of pin holes, such as an outer row of pin holes 524 disposed along an outer edge of the bottom area 522 and/or a middle row of pin holes 526 disposed along an inner edge of the bottom area 522. The outer row of pin holes 524 can extend in the axial direction through the section 514 of the outer wall 414 so that the cooling air can exit a top edge 528 of the outer wall 414. Also, the middle row of pin holes 526 can extend in the axial direction through the section 510 of the divider wall 412 so that the cooling air can exit a top edge 530 of the divider wall 412. Similarly, an inner heat shield section 532 can include an inner row of pin holes 534 that extends through the section 506 of the inner wall 410, such that the cooling air can pass through the inner wall 410 and exit out a top edge 530 of the inner wall 410. In this way, the internal cooling circuit 124 including the plurality of pin holes can be axially aligned. This configuration of pin holes passing through the inner wall 410, the divider wall 412, and/or the outer wall 414 can ensure that some of the cooling air gets released between each individual heat shield. Moreover, the pin holes 524, 526, and/or 534 can form an integral part of the cooling system of the heat shield portions 500. The pin holes 524, 526, and/or 534 can ensure that the heat from the hot side of the heat shield gets dispersed directly into the flow path of the cooling air flowing through each heat shield as it exits from the top edge outlets. The pinholes can also have side outlets 536 disposed along sides edges 538 of the inner wall 410, divider wall 412, and/or outer wall 414 for further distributing the cooling air flow through the heat shield 126. As such, the pin holes 524, 526, and/or 534 can form the internal cooling circuit 124 through the walls of the heat shield 126.

Turning to FIGS. 5C and 5D, the system 100 can include additively manufactured heat shield portions 504. The additively manufactured heat shield portions 504 shown in FIGS. 5C and 5D can be similar to, identical to, and/or can form at least a portion of the system 100 (e.g., the combustion chamber 112) shown in FIG. 1.

In some scenarios, the additively manufactured heat shield portions 504 can have features, shapes, and dimensions similar to and/or identical to those of the heat shield portions 500 of the initial heat shield 400, such that the additively manufactured heat shield portions 504 can form a replacement heat shield 126. For instance, the additively manufactured heat shield portions 504 can include the section 506 of the inner wall 410 extending (e.g., perpendicularly) from the section 508 of the first base surface 408 of the inner heat shield portion 404. The additively manufactured heat shield portions 504 can also include the section 510 of the divider wall 412 extending parallel to the section 506 of the inner wall 410 and dividing the section 508 of the first base surface 408 from the section 512 of the second base surface 416. Additionally, the additively manufactured heat shield portions 504 can include the first opening 516 in the first base surface 408 for receiving the internal cooling circuit 124. The additively manufactured heat shield portions 504 can also include the second opening 518 in the second base surface 416 for receiving the internal cooling circuit 124. As such, the additively manufactured heat shield portions 504 can align the internal cooling circuit 124 axially. A plurality of the additively manufactured heat shield portions 504 can be arranged in a circle to form the additive manufactured heat shield (e.g., shroud).

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system of gas turbine cooling, the system comprising:
a combustion chamber of a gas turbine with an interior portion; and
a heat shield of an internal cooling circuit, the heat shield being additively manufactured and being at least partly disposed inside the combustion chamber.

2. The system of claim 1, wherein the heat shield is additively manufactured by starting from layers of a metal powder material.

3. The system of claim 1, wherein the heat shield extends axially into the interior portion of the combustion chamber.

4. The system of claim 1, wherein the heat shield extends into the interior portion of the combustion chamber and is substantially parallel to a central axis of the combustion chamber.

5. The system of claim 1, wherein the heat shield includes one or more openings to axially align the internal cooling circuit.

6. The system of claim 1, wherein the heat shield is disposed upstream from one or more rotating components of the gas turbine.

7. The system of claim 6, wherein the one or more rotating components include at least one of a turbine blade or an exhaust fan.

8. A gas turbine cooling device comprising:
a heat shield of an internal cooling circuit configured to extend into an interior portion of a combustion chamber of a gas turbine, and the heat shield is additively manufactured using layers of metal powder.

9. The device of claim 8, wherein the heat shield has a metallographic structure refined by a heat treatment step.

10. The device of claim 8, wherein the heat shield extends into the interior portion of the combustion chamber at least partly along a central axis of the combustion chamber.

11. The device of claim 8, wherein the heat shield extends at least partly along an axis defined by an arrangement of the combustion chamber with a fuel injector assembly.

12. The device of claim 8, wherein the heat shield extends at least partly along an axis defined by an arrangement of the combustion chamber with a turbine.

13. The device of claim 8, wherein the heat shield includes an inner heat shield portion separated from an outer heat shield portion by an axially aligned divider wall.

14. The device of claim 8, wherein the heat shield is disposed in the gas turbine around static components of the gas turbine.

15. The device of claim 8, wherein the heat shield is disposed upstream from a hot gas path of the gas turbine.

16. A method of cooling a gas turbine, the method comprising:
forming an additively manufactured heat shield of an internal cooling circuit using an additive manufacturing machine;
disposing the additively manufactured heat shield at least partly inside a combustion chamber of a gas turbine system; and
reducing a temperature of the gas turbine system by circulating a cooling fluid through the internal cooling circuit.

17. The method of claim 16, wherein forming the additively manufactured heat shield includes forming a metallographic structure using layers of metal powder.

18. The method of claim 16, wherein disposing the additively manufactured heat shield in the gas turbine system includes disposing the additively manufactured heat shield in a static portion of the gas turbine system upstream from rotating components or downstream from the rotating components.

19. The method of claim 16, wherein reducing the temperature of the gas turbine system includes circulating the cooling fluid at least partly through an interior portion of the combustion chamber.

20. The method of claim 19, wherein the cooling fluid flows axially and non-radially through the interior portion of the combustion chamber.
